(19) United States
(12) Patent Application Publication
(10) Pub. No.: US 2009/0283027 A1
(43) Pub. Date: Nov. 19, 2009

(54) Global gravitational horizon

(75) Inventors: Melinda Marie Cameron, Nampa, ID (US); Scott David Bartholdson, Port Orange, FL (US)

Correspondence Address: Melinda Cameron, 204 Juniper St, Nampa, ID, 83686, US

(73) Assignees: Melinda Marie Cameron, Nampa, FL (US); Scott David Bartholdson, Port Orange, FL (US)

(21) Appl. No.: 12/387,953

(22) Filed: May 11, 2009

Related U.S. Application Data
(60) Provisional application No. 61/071,804, filed on May 19, 2008.

(51) Int. Cl. G01C 21/00

(52) U.S. Cl. 116/215

(57) ABSTRACT

The Global Gravitational Horizon (GGH) is a system of two concentric spheres, one affixed to the center of gravity, the other affixed to the aircraft, both in juxtaposition representing a reference so that a pilot can always know the exact flight attitude without having to rely on any complicated, vulnerable, and conventional flight attitude indicators. The GGH requires virtually no experience or training to understand, therefore will be extremely helpful to new and novice pilots as well as seasoned pilots who are desirous of having a constant real time reference to their position relating to the horizon/ground without having to worry about maintenance or failure.

### CROSS-REFERENCE TO RELATED APPLICATIONS

This application claims priority to U.S. Provisional Application No. 61/071,804, entitled “Global Gravitational Horizon” and filed on May 19, 2008, the disclosure of which is hereby incorporated in its entirety by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Several different scenarios culminated in the advent of the Global Gravitational Horizon (GGH). Fundamentally the need for a simple, reliable, and consistent flight attitude indicator is statistically represented by the number of accidents that occur within the realm of inexperienced/novice pilots.

1. Field of the Invention

The GGH is primarily for non-commercial light aircraft, however it can be used, if desired, in any aircraft.

2. Description of Related Art

Not Applicable

### BRIEF SUMMARY OF THE INVENTION

The GGH is a simple, reliable, constant representation of the aircraft in flight in relation to the horizon or ground. Comprised of very few moving parts that are virtually unbreakable and require no outside power source the GGH is extremely dependable.

### BRIEF DESCRIPTION OF THE DRAWINGS

FIG. 1 illustrates the clear outer plastic sphere of the GGH including a silhouette of an aircraft, and markings for degrees of banking,

FIG. 2 illustrates the inner plastic sphere of the GGH at ½ scale depicting interior and exterior views,

FIG. 3 illustrates the inner and outer spheres of the GGH in juxtapositon,

FIG. 4 illustrates the side view of the GGH as a whole

### DETAILED DESCRIPTION OF THE INVENTION

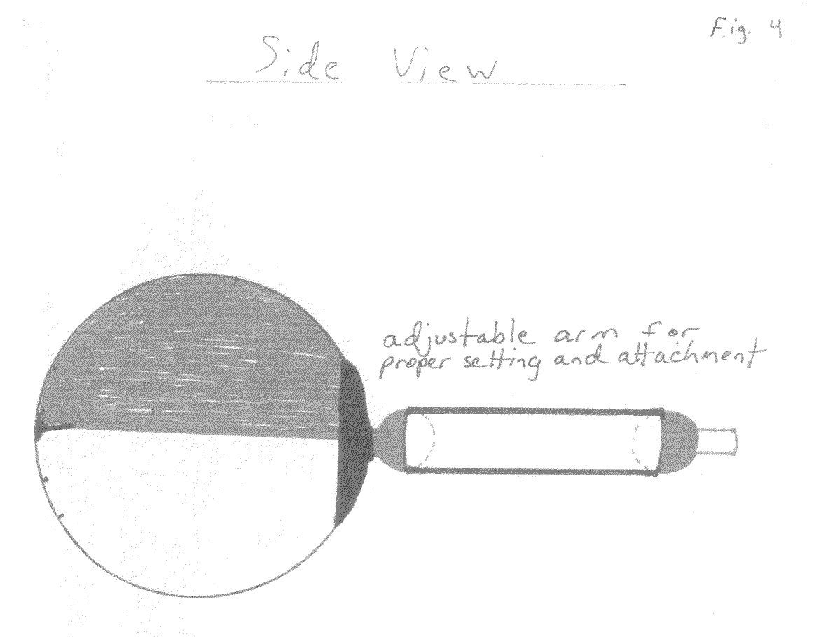

The GGH is a constant real-time horizon. The outer sphere of the GGH is affixed to the inside of the cockpit; when the aircraft moves in any direction, by any degree, the outer sphere moves with it. The inner sphere of the GGH is weighted so as to stay oriented by gravity. Using liquid as a buffer each sphere moves independently, allowing both spheres to function in juxtaposition as a unit (similar to a spherical compass) as shown in FIG. 4.

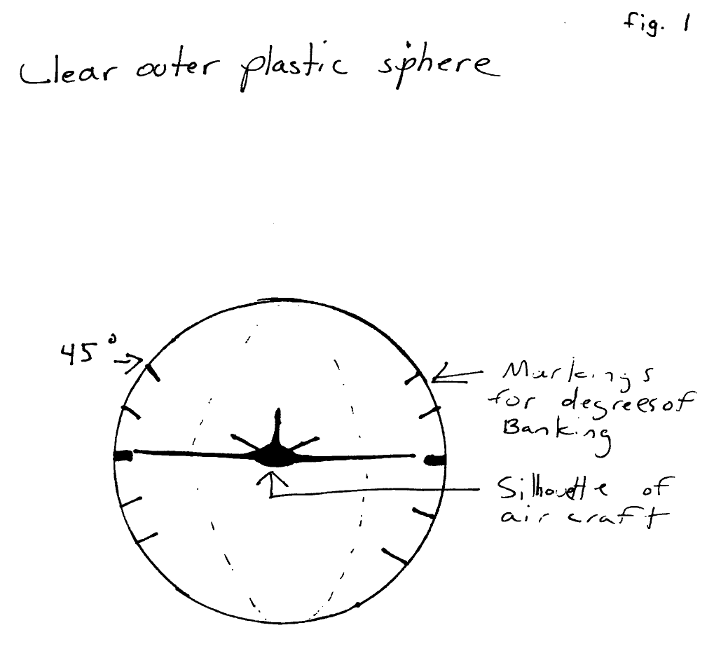

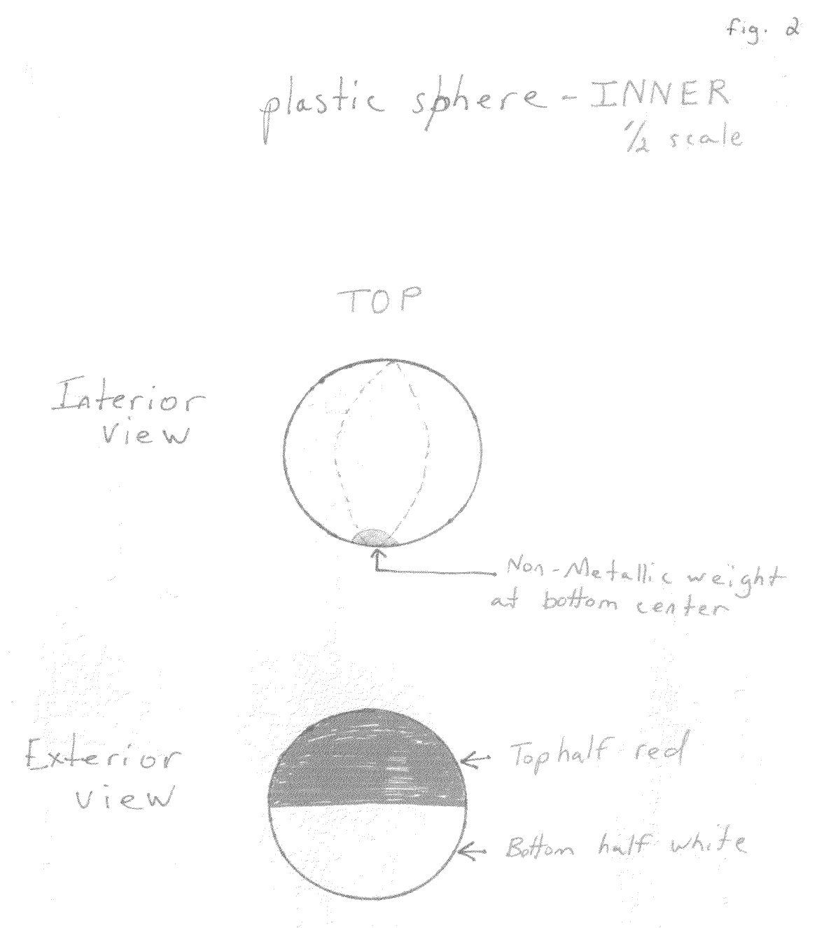

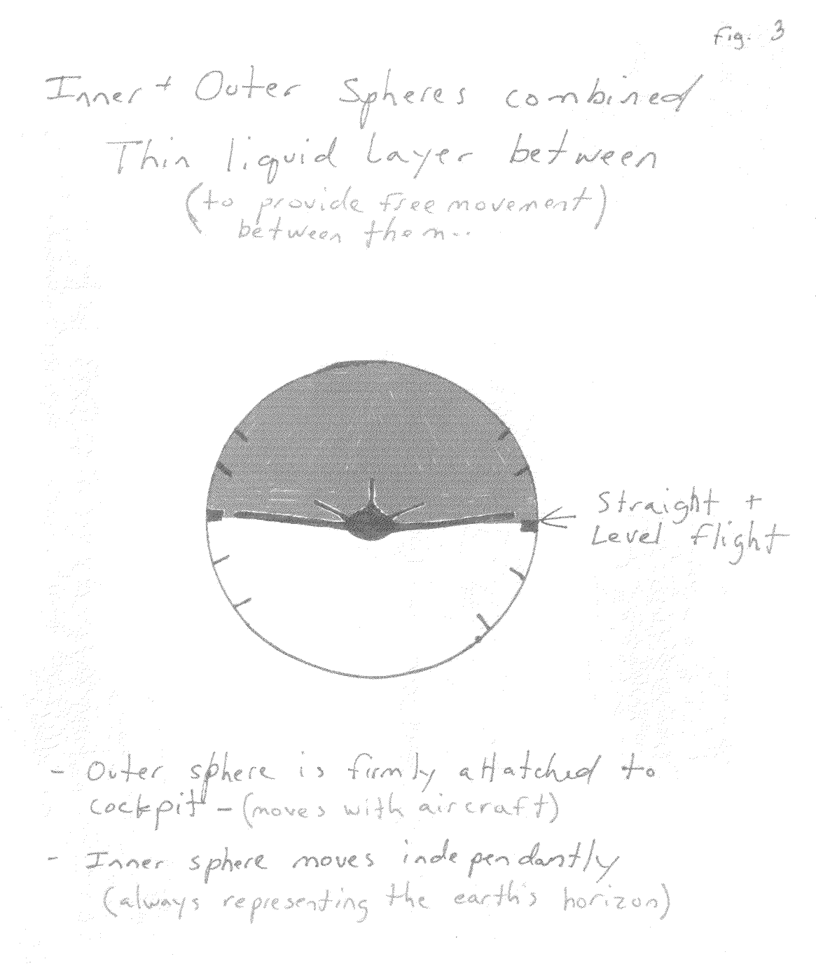

An image of an aircraft in straight and level flight is displayed on the outer sphere (see FIG. 1). The inner sphere is divided into two colors, red and white; where they meet represents the horizon (see FIG. 2). During straight and level flight the image of the aircraft on the outer sphere is aligned with the horizon represented on the inner sphere (see FIG. 3). As a result of the two images juxtaposed, any variations in pitch and roll are constantly displayed in real time. These crucial aircraft movements are indicated without complicated mechanical or electrically reliant devices; no superfluous readings, failures, or wear: the idea being, the less moving parts, the less to go wrong. Easy to understand and accurate, the GGH is designed to be the most reliable flight attitude indicator to date.

The playing field for pilots is fundamentally not skill based, but experience based; beginner pilots are required to perform the same tasks as seasoned pilots. Part of the goal of the GGH is to even the playing field. Flight planning, reading multiple gauges, compensating for inclement weather, and navigating are complicated enough; being aware of an aircrafts' orientation at all times should not add to a pilots challenges. A single glance at the GGH provides a dependable representation of flight attitude. By design the GGH allows even new pilots to rise above difficulties in perception, adverse conditions, or inexperience. The Wright brothers defied gravity and took us to the sky; the Global Gravitational Horizon returns us safely to earth.

What is claimed is:

1. The GGH is an artificial horizon designed to last the life-time of any aircraft, requiring no upkeep, maintenance, or replacement. The GGH is capable of all-weather flying, day or night flying, and it does not rely on any condition for it to function properly.

2. An artificial horizon as in claim 1, wherein the design and simplicity renders the GGH to be the safest, most reliable, and effective flight attitude indicator to date.

3. An artificial horizon as in claim 2, wherein two plastic spheres separated by a clear viscous liquid that is resistant to freezing allows both spheres, while in juxtapositon, to move freely and separately from one another.

4. An artificial horizon as in claim 3, wherein the inner sphere is weighted with a non-metallic weight such as to affix itself using gravity and therefore alining the inner sphere to the horizon while simultaneously the outer sphere depicts an aircraft in flight and moves with the aircraft in real time.

5. An artificial horizon as in claim 4, wherein the primary colors (based upon VASI lights) are used to help pilots improve familiarity and decrease confusion in the event of a stall or inadvertant steep climb due to loss of visual reference of the horizon.

6. An artificial horizon as in claim 5, wherein the aircraft depicted on the outer sphere in straight and level flight would have a red sky and white earth—“red over white” hence would be straight and level flight. Just viewing red would represent a dive or stall hence if you see red you will be dead, stop and correct your flight attitude. This is very similar to the saying that is attached to the VASI lights, therefore rendering pilot error at a minimum.

7. An artificial horizon as in claim 6, wherein pitch and roll are accurately depicted in real time.

8. An artificial horizon as in claim 7, wherein no outside power source/supply is necessary, nor are there any gyroscopic, complex circuitry, or vacuum apparatus required, rendering it extremely reliable.
